(19) United States
(12) Patent Application Publication
(10) Pub. No.: US 2007/0028121 A1
(43) Pub. Date: Feb. 1, 2007

(54) Method of protecting confidential data using non-sequential hidden memory blocks for mass storage devices

(76) Inventor: Hsiang-Chi Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/490,044

(22) Filed: Jul. 21, 2006

(30) Foreign Application Priority Data
Jul. 29, 2005 (TW) 094125945

(51) Int. Cl. G06F 12/14; H04L 9/32; G06F 11/30

(52) U.S. Cl. 713/193

(57) ABSTRACT

A method of protecting confidential data using a non-sequential hidden block mechanism is provided, including the following steps of: (a) configuring the size of the confidential file; (b) the electronic host reading the capacity of the physical memory; (c) configuring the capacity of usable physical memory space; (d) the electronic host writing confidential data; (e) generating a random access lookup table (LUT) of address space; (f) using a random function to generate random address within a certain range and storing into the random LUT sequentially; and (g) sequentially mapping the logic addresses of the confidential data to the random LUT, and writing the mapped physical addresses to the physical memory blocks. Through the above steps, the mass storage device, such as no-volatile memory and hard disk, can store the data non-sequentially to achieve the object of confidential data protection.

### BACKGROUND OF THE INVENTION

1. Field of the Invention

The present invention relates to a method of protecting confidential data using non-sequential hidden memory blocks for mass storage device and, more particularly, to a method applicable to non-volatile memory and hard disk by using non-sequential data storage to protect the confidential information.

2. The Related Arts

Mass storage devices, such as non-volatile memory and hard disk, are widely used in peripheral electronic devices for storage media, including portable hard disk, hard disk connected to notebook PC, or PDA. Therefore, it is becoming increasingly important that the personal confidential information stored in the storage devices, such as non-volatile memory or hard disk are well protected.

The conventional methods of protecting confidential data are mostly using password, or fingerprint identification, or personal ID as authorization of accessing confidential data. This usually poses a huge security loop. For example, when a mass storage device, such as a hard disk, or non-volatile memory device (for example flash memory) is removed from the host and reconnected to another host, a sequential search method, such as searching using FAT12, FAT16, FAT32, NTFS format, can easily access the contents of the hard disk or non-volatile memory. The confidential data can therefore be stolen.

### SUMMARY OF THE INVENTION

The present invention is made to overcome the aforementioned drawback of the current technologies. The primary object of the present invention is to provide a method of protecting confidential data using a non-sequential hidden memory block mechanism for mass storage devices. The present invention employs a random access lookup table (LUT) of address space and a random number generator to generate random numbers for storing in the random LUT sequentially. When the non-volatile memory and hard disk store data, they can use the random number in the random LUT to avoid the sequential storing of data. Hence, the conventional sequential search method cannot break the protection and access the confidential data.

Another object of the present invention is to provide a method of protecting confidential data using a non-sequential hidden memory block mechanism for mass storage devices, using a non-sequential method to randomly store confidential data into the storage. Therefore, when a mass storage device is removed and reconnected to a different host, the sequential access method cannot correctly read the data from the mass storage device.

To achieve the above objects, the present invention provides a method of protecting confidential data using a non-sequential hidden block mechanism, including the following steps of:

(a) configuring the size of the confidential file;

(b) the electronic host reading the capacity of the physical memory;

(c) configuring the capacity of usable physical memory space;

(d) the electronic host writing confidential data;

(e) generating a random access lookup table (LUT) of address space;

(f) using a random function to generate random address within a certain range and storing into the random LUT sequentially; and

(g) sequentially mapping the logic addresses of the confidential data to the random LUT, and writing the mapped physical addresses to the physical memory blocks.

Through the above steps, the mass storage device, such as no-volatile memory and hard disk, can store the data non-sequentially to achieve the object of confidential data protection.

These and other objects, features, and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a flowchart of the present invention; and

FIG. 2 is a schematic view of the mapping between random access lookup table and physical memory address.

### DETAILED DESCRIPTION OF THE INVENTION

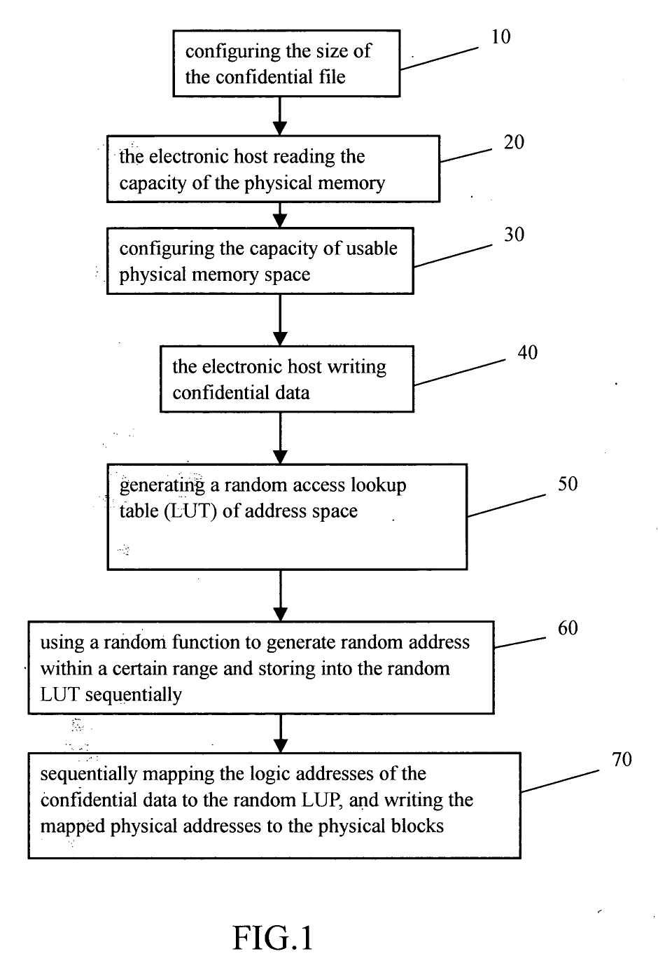

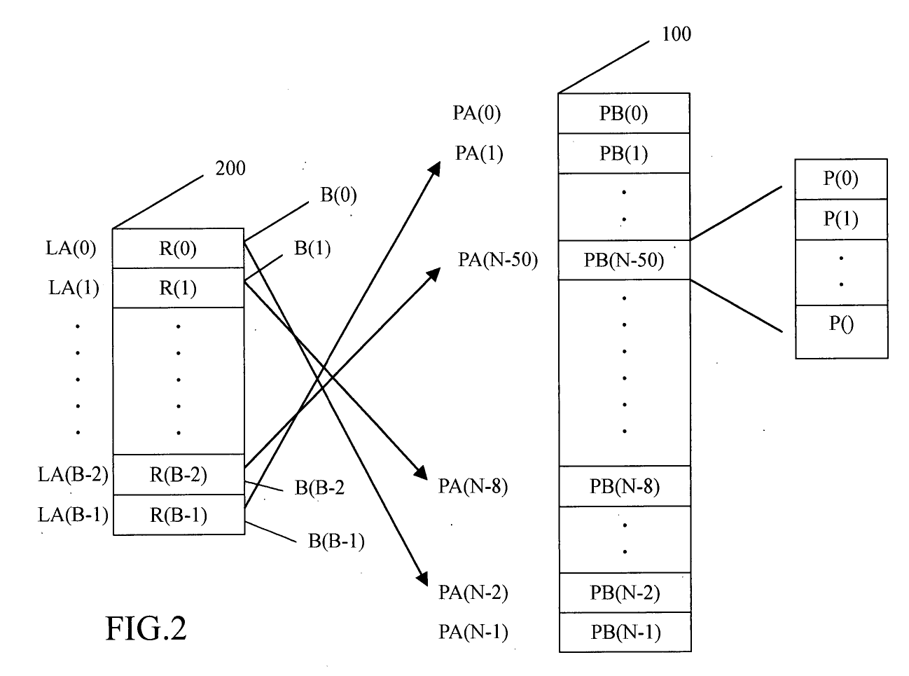

Referring now to FIGS. 1 and 2, which are a flowchart and a memory mapping block diagram of a method of protecting confidential data using a non-sequential hidden memory block mechanism for mass storage devices of the present invention. The present invention is applicable to a mass storage device 100 (as shown in FIG. 2). The mass storage device 100 is not limited to any specific type. A non-volatile memory is used as an embodiment of the present invention; however, other types of mass storage devices, such as hard disk, are also within the scope of the present invention. The method of the present invention includes the following steps of:

(10) configuring the size of the confidential file: The user inputs to set the size of the confidential file in the mass storage device 100. If the memory capacity is Y bytes, the minimum access unit is a page of 1024 (1k) bytes, and the size of the confidential file is M pages, the size of the confidential file is M*k bytes.

(20) the electronic host reading the capacity of the physical memory: The electronic host connected to the mass storage device 100, such as notebook computer, a personal computer, a personal digital assistant, a tablet computer, a game box, and a card reader, reads the capacity of the mass storage device 100. For example, the storage capacity is Y bytes.

(30) configuring the capacity of usable physical memory space: The actual usable space, called physical memory capacity, for the mass storage device 100 is Y-M*k bytes. The physical memory capacity is configured into N physical blocks PB(0)-PB(N−1). Each physical block PB(0)-PB(N−1) includes X physical pages P(0)-P(X−1). Each physical block PB(0)-PB(N−1) corresponds to a physical address PA(0)-PA(N−1), respectively. It can be derived that the relationship between number of physical blocks PB(0)-PB(N−1) and the memory capacity is N=(Y/1024)/X.

(40) the electronic host writing confidential data: The electronic host writes the M pages of confidential data to the mass storage device 100.

(50) generating a random access lookup table (LUT) of address space: The M pages of confidential data written to the mass storage device 100 is configured into B access blocks B(0)-B(B−1), with each access block B(0)-B(B−1) including X pages. Each page is 1024(1 k) bytes, and therefore B=M/X. The B access blocks B(0)-B(B−1) generate B logical addresses LA(0)-LA(B−1). The B logical addresses LA(0)-LA(B−1) correspond to the B access blocks B(0)-B(B−1), and the corresponding relationship generates a random access lookup table (LUT) 200.

(60) using a random function to generate random address within a certain range and storing into the random LUT sequentially: A random function is used to generate B random addresses R(0)-R(B−1) within the range of 0-(N−1). The generated random addresses R(0)-R(B−1) are sequentially stored to access blocks B(0)-B(B−1) corresponding to logical addresses LA(0)-LA(B−1) of the random LUT 200 of step (50). Random addresses R(0)-R(B−1) are used as indexes to map to physical addresses PA(0)-PA(N−1) of the mass storage device 100.

(70) sequentially mapping the logic addresses of the confidential data to the random LUT, and writing the mapped physical addresses to the physical memory blocks: Random addresses R(0)-R(B−1) stored in access blocks B(0)-B(B−1) corresponding to logical addresses LA(0)-LA(B−1) of the random LUT 200 are sequentially read for using as physical address PA(0)-PA(N−1) of the non-volatile memory. After the mapping between logical addresses LA(0)-LA(B−1) and physical addresses PA(0)-PA(N−1), the data is accessed to physical blocks PB(0)-PB(N−1) corresponding to physical addresses PA(0)-PA(N−1).

The actual operation of the method of the present invention, as shown in FIG. 2, employs a random access LUT 200. B random addresses R(0)-R(B−1) are stored in access blocks B(0)-B(B−1) of logical addresses LA(0)-LA(B−1) of the random LUT 200. The contents of random address R(0), R(1), R(B−2), R(B−1) are N−2, N−8, N−50, 1, respectively. Therefore, logical addresses LA(0), LA(1), LA(B−2), LA(B−1) map to physical addresses PA(N−2), PA(N−8), PA(N−50), PA(1), and the data is stored in physical blocks PB(N−2), PB(N−8), PB(N−50), PB(1). In this manners, physical blocks PB(0)-PB(N−1) are non-sequentially hidden to avoid the conventional sequential search methods using FAT12, FAT 16, FAT 32, NTFS, and so on formats from correctly accessing the confidential data.

The mass storage device 100 and the random LUT 200 of the present invention are not limited to any specific type. For example, the random LUT 200 can be an application program pre-installed in an electronic host, such as a personal computer, a notebook computer, a personal digital assistant, a tablet computer, a card reader, or a driver or data conversion application program stored in other portable mass storage device, including DVD, DVD-RW, CD, CD-RW, hard disk, flash memory card, and so on.

While the present invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. A method of protecting confidential data using non-sequential hidden memory blocks for mass storage devices, applicable to said mass storage devices connected or included in an electronic host, said method comprising the following steps of:
(a) configuring size of a confidential file, a user setting the size of said confidential file in said mass storage device;
(b) said electronic host reading the capacity of the physical memory of said mass storage device;
(c) configuring the capacity of usable physical memory space, subtracting said size of said step (a) from said capacity of said step (b), said actual usable space configured into a plurality of physical blocks, with each said physical block corresponding to a physical address;
(d) said electronic host writing said confidential data to mass storage device according to configuration in said step (a);
(e) generating a random access lookup table (LUT) of address space, configuring said confidential data written to said mass storage device in said step (d) into a plurality of access blocks, with each said access block generating a logical address, each said logical address corresponding to a said access block, and said corresponding relationship generating a random access lookup table (LUT);
(f) using a random function to generate random addresses within a certain range and storing into the random LUT sequentially, said random function being used to generate a plurality of random addresses within a certain range, said random addresses being sequentially stored to said access blocks corresponding to said logical addresses of said random LUT of said step (e), said random addresses being used as indexes to map to said physical addresses of said mass storage device; and
(g) sequentially mapping said logic addresses of said confidential data to said random LUT, and writing said mapped physical addresses to said physical blocks, said random addresses stored in said access blocks corresponding to said logical addresses of said random LUT being sequentially read for using as said physical address of said non-volatile memory, performing said mapping between said logical addresses and said physical addresses, said confidential data being accessed to said physical blocks corresponding to said physical addresses.

2. The method as claimed in claim 1, wherein said mass storage device of said step (a) is a non-volatile memory.

3. The method as claimed in claim 1, wherein said mass storage device of said step (a) is a hard disk.

4. The method as claimed in claim 1, wherein said electronic host of said step (b) is a personal computer.

5. The method as claimed in claim 1, wherein said electronic host of said step (b) is a notebook computer.

6. The method as claimed in claim 1, wherein said electronic host of said step (b) is a personal digital assistant.

7. The method as claimed in claim 1, wherein said electronic host of said step (b) is a tablet computer.

8. The method as claimed in claim 1, wherein said usable physical memory space of said mass storage device of said step (c) is equal to the capacity of said mass storage device minus the size of said confidential file.

9. The method as claimed in claim 1, wherein each said physical block of said step (c) comprises a plurality of physical pages.

10. The method as claimed in claim 1, wherein each said access block of said step (e) comprises a plurality of pages.
